(19) United States
(12) Patent Application Publication
(10) Pub. No.: US 2008/0073895 A1
(43) Pub. Date: Mar. 27, 2008

(54) Portable storage apparatus for granular material

(75) Inventors: Alvin Herman, Clavet (CA); Claude La Voie, Sherwood Park (CA); Erin Herman, Clavet (CA)

Correspondence Address: NIXON & VANDERHYE, PC, 901 NORTH GLEBE ROAD, 11TH FLOOR, ARLINGTON, VA, 22203, US

(73) Assignee: Sand Castle Enterprises, Inc., Martensville (CA)

(21) Appl. No.: 11/641,826

(22) Filed: Dec. 20, 2006

(30) Foreign Application Priority Data
Sep. 14, 2006 (CA) 2,560,109

(51) Int. Cl. B60P 3/22

(52) U.S. Cl. 280/839

(57) ABSTRACT

A portable storage tank apparatus includes a tank shell mounted on wheels to be towed to a work site and adapted to be supported at the work site store granular material. An outlet opening has a gate to discharge stored material from the shell. A front loading conduit has an interior end at a top portion of an interior of the tank shell, and an exterior end located near the front end of the tank shell, and a rear loading conduit has an interior end at a top portion of the interior of the tank shell, and an exterior end located near the rear end of the tank shell. The exterior ends of the loading conduits are adapted for connection to a discharge pipe of a pneumatic conveyor to receive an air stream carrying granular material. Multiple tank compartments and a pneumatic conveyor unloading circuit can be provided as well.

This invention relates to portable storage equipment and more specifically to a portable storage bin for granular material with multiple compartments.

### BACKGROUND

Portable storage tanks are well known in various industries for on site storage of various granular materials such as sand, cement, salt, fertilizer, and the like. Such portable tanks typically comprise a tank mounted on wheels and including a hitch, commonly a fifth wheel type hitch. The empty tank is towed to a work site where it is supported suitably to accommodate the weight of the granular material being stored, and then the tank filled with granular material. The tank may have a plurality of legs attached thereto that can be lowered when the tank is at the work site to support the loaded tank, or the tank can be supported by blocks or the like as required.

It is common for such portable storage tanks to include a loading conduit to allow connection to discharge pipes of a pneumatic conveyor on a transport vehicle such that granular material can be conveyed into the tank by the pneumatic conveyor. Such pneumatic conveyors typically comprise a blower operative to create an air stream in a pipe. The pipe is connected to a storage vessel on the transport vehicle to receive a flow of granular material that mixes with the air stream and is carried along the pipe. A loading conduit on the portable storage tank is connected to the pipe, and the air stream and granular material mixed therein move through the loading conduit to a discharge end of the loading conduit located in an upper portion of the storage tank where the granular material falls out of the air stream into the tank. The tank is vented to allow the air stream entering the tank to escape.

Typically the portable storage tank will include hoppered bottom discharge openings that can be connected to pipes of a pneumatic conveyor to convey granular material flowing from the discharge opening through the pipe. Depending on the material being stored, the hoppers may require fluidizer devices at the bottom that are connected to pressurized air from a pneumatic conveyor. As is well known in the prior art, where the granular material is fine and subject to packing and poor flow characteristics, air can be passed through the granular material to “fluidize” the material and promote flow out through the discharge opening into the air stream in the pneumatic conveyor pipe.

When unloading granular material from the tank with a pneumatic conveyor, it is necessary to pressurize the tank interior so that the air above the granular material in the tank is the same pressure as the air in the pneumatic conveyor pipe into which the granular material is flowing. Typically a conduit connects the pneumatic conveyor pressure pipe to the top of the tank, and air flows into the tank only until the pressure in the tank is equal to that in the pipe. The tank must therefore be designed to withstand a pressure inside the tank that is equal to the pressure developed inside the pneumatic conveyor pipe. Such tanks thus typically are cylindrical with coned or domed ends.

In conventional portable storage tanks, the tank interior may be divided into a plurality of compartments by walls, thus allowing different products to be stored in the same tank. The walls are designed to withstand the force exerted by granular material in a fully loaded compartment on one side of the wall toward an adjacent empty compartment. The walls are not strong enough to support a differential in the air pressure in one compartment relative the next. Thus in order to prevent collapse of the walls, the compartments are connected, typically by a gap between the top of the walls and the top of the tank, so that air can flow freely from one compartment to the next.

Since the whole tank interior must be pressurized to unload one compartment, it is not possible to unload one compartment while loading into another. Such prior art portable storage tanks are further limited in that only one location is provided for connecting pipes of a pneumatic conveyor to either convey granular material into the tank or remove granular material from the tank.

### SUMMARY OF THE INVENTION

It is an object of the present invention to provide a portable storage tank apparatus that overcomes problems in the prior art.

In a first embodiment the present invention provides a portable storage tank apparatus for storing granular material comprising a tank shell mounted on wheels and adapted to be towed to a work site by a towing vehicle, and adapted to be supported at the work site to receive and store granular material. An outlet opening at a bottom portion of the tank shell has a gate operative to selectively discharge stored granular material through the outlet opening. A front loading conduit has an interior end located inside the tank shell at a top portion of an interior of the tank shell, and an exterior end located in proximity to a front end of the tank shell, and a rear loading conduit has an interior end located inside the tank shell at a top portion of the interior of the tank shell, and an exterior end located in proximity to a rear end of the tank shell. The exterior ends of the front and rear loading conduits are adapted for connection to a discharge pipe of a pneumatic conveyor to receive an air stream carrying granular material from the discharge pipe.

In a second embodiment the present invention provides a portable storage tank apparatus for storing granular material comprising a tank shell mounted on wheels and adapted to be towed to a work site by a towing vehicle, and adapted to be supported at the work site to receive and store granular material. A wall divides an interior of the tank shell into first and second compartments such that air is prevented from moving between the first and second compartments. First and second outlet openings at bottom portions of the corresponding first and second compartments have first and second gates operative to selectively discharge stored granular material through the corresponding first and second outlet openings. A first front loading conduit has an interior end located at a top portion of the first compartment, and an exterior end located in proximity to a front end of the tank shell. A second front loading conduit has an interior end located at a top portion of the second compartment, and an exterior end located in proximity to a front end of the tank shell. A first rear loading conduit has an interior end located at a top portion of the first compartment, and an exterior end located in proximity to a rear end of the tank shell. A second rear loading conduit has an interior end located at a top portion of the second compartment; and an exterior end located in proximity to a rear end of the tank shell. The exterior ends of the loading conduits are adapted for connection to a discharge pipe of a pneumatic conveyor to receive an air stream carrying granular material from the discharge pipe.

In a third embodiment the present invention provides portable storage tank apparatus for storing granular material comprising a tank shell mounted on wheels and adapted to be towed to a work site by a towing vehicle, and adapted to be supported at the work site to receive and store granular material. Interior walls divide an interior of the tank shell into first, second, and third compartments such that air is prevented from moving between the compartments. First, second, and third outlet openings at bottom portions of the corresponding first, second, and third compartments have first, second, and third gates operative to selectively discharge stored granular material through the corresponding first, second, and third outlet openings. A first front loading conduit has an interior end located at a top portion of the first compartment, and an exterior end located in proximity to a front end of the tank shell. A second front loading conduit has an interior end located at a top portion of the second compartment, and an exterior end located in proximity to the front end of the tank shell. A third front loading conduit has an interior end located at a top portion of the third compartment, and an exterior end located in proximity to the front end of the tank shell. A first rear loading conduit has an interior end located at a top portion of the first compartment, and an exterior end located in proximity to a rear end of the tank shell. A second rear loading conduit has an interior end located at a top portion of the second compartment, and an exterior end located in proximity to the rear end of the tank shell. A third rear loading conduit has an interior end located at a top portion of the third compartment, and an exterior end located in proximity to the rear end of the tank shell. The exterior ends of the loading conduits are adapted for connection to a discharge pipe of a pneumatic conveyor to receive an air stream carrying granular material from the discharge pipe.

Where it is desired to also unload the apparatus with a pneumatic conveyor, the apparatus can conveniently include a material removal circuit connected to the outlet openings and operative to allow a pressure pipe from a pneumatic conveyor to be connected to the circuit in proximity to either one of the front end and the rear end of the tank shell to direct an air stream into the circuit, and operative to allow a discharge pipe to be connected to the circuit in proximity to either one of the front end and the rear end of the tank shell to receive the air stream and any granular material discharged from the outlet openings.

The apparatus thus allows loading, and unloading if desired, from either end. The apparatus can be configured to be connected to a pneumatic conveyor to remove granular material from two separate compartments, and blend same in the air stream and deposit the blended granular material into a third compartment

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a side view of an embodiment of a portable storage tank apparatus of the invention for storing granular material;

FIG. 2 is a rear view of the embodiment of FIG. 1;

FIG. 3 is a schematic top view showing the configuration of the loading conduits of the embodiment of FIG. 1;

FIG. 4 is a schematic side view showing the configuration of the material removal circuit of the embodiment of FIG. 1.

### DETAILED DESCRIPTION OF THE ILLUSTRATED EMBODIMENTS

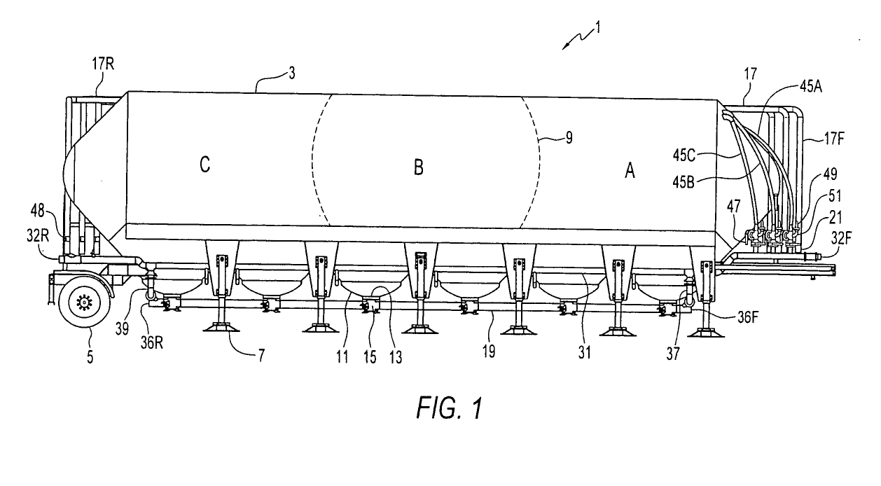

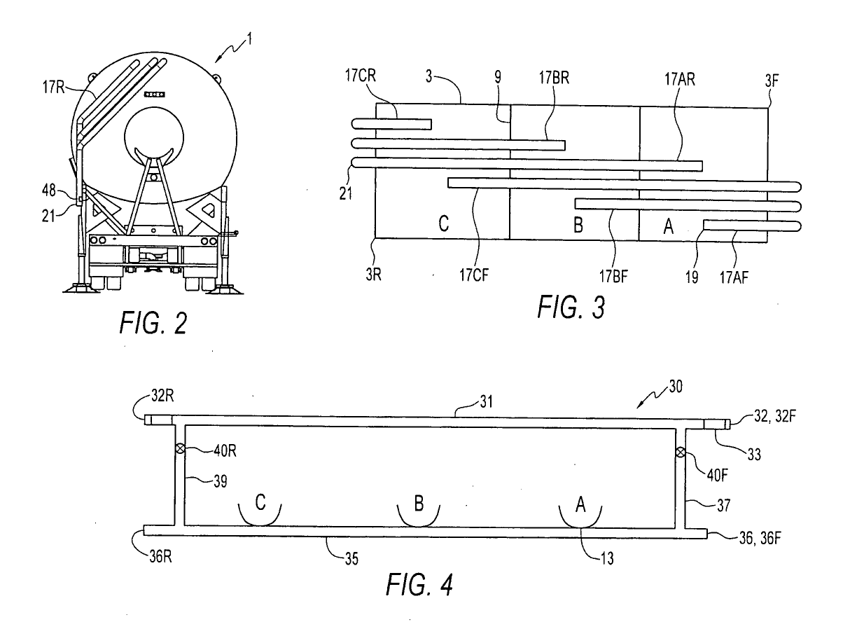

FIGS. 1-4 illustrate an embodiment of a portable storage tank apparatus 1 of the invention for storing granular material. The apparatus 1 comprises a tank shell 3 mounted on wheels 5 and adapted to be towed to a work site by a towing vehicle attached to a hitch at the front end of the tank shell 3. The wheels 5 are designed to carry the empty apparatus 1 to a work site where the apparatus 1 will be supported to receive and store granular material. The illustrated apparatus 1 includes legs 7 that can be lowered at the work site to support the weight of the apparatus 1 when it is loaded with granular material. Alternative supports, blocking, foundations, and the like could also be configured to support the apparatus 1 as well.

Interior walls 9 divide an interior of the tank shell 3 into first, second, and third compartments A, B, C such that air is prevented from moving between the compartments. The compartments each have a pair of hoppers 11 and an outlet opening 13 at the bottom of each hopper. A gate 15, provided by a butterfly valve or like mechanism, in each opening 13 is operative to selectively discharge stored granular material through the outlet opening 13.

FIG. 3 schematically illustrates the arrangement of front and rear loading conduits 17F, 17R on the illustrated apparatus 1. A first front loading conduit 17AF has an interior end 19 located at a top portion of the first compartment A, and an exterior end 21 located in proximity to a front end 3F of the tank shell 3. A second front loading conduit 17BF has an interior end 19 located at a top portion of the second compartment B, and an exterior end 21 located in proximity to the front end 3F of the tank shell 3. A third front loading conduit 17CF has an interior end 19 located at a top portion of the third compartment C, and an exterior end 21 located in proximity to the front end 3F of the tank shell 3.

Similarly, a first rear loading conduit 17AR has an interior end 19 located at a top portion of the first compartment A and an exterior end 21 located in proximity to the rear end 3R of the tank shell 3. A second rear loading conduit 17BR has an interior end 19 located at a top portion of the second compartment B and an exterior end 21 located in proximity to the rear end 3F of the tank shell 3. A third rear loading conduit 17CR has an interior end 19 located at a top portion of the third compartment C and an exterior end 21 located in proximity to the rear end 3R of the tank shell 3.

The exterior ends 21 of the loading conduits are adapted for connection to a discharge pipe of a pneumatic conveyor to receive an air stream carrying granular material from the discharge pipe. The discharge pipe of a pneumatic conveyor carrying granular material from a transport vehicle can be connected to any one of the loading conduits 17 to convey the granular material into the desired compartment. Thus the compartments may be filled from a transport vehicle located at either the front end 3F or the rear end 3R of the tank shell 3. The compartments are sealed with respect to each other so there is no possibility that granular material from one compartment will contaminate a different material in an adjacent compartment.

For example to fill compartment C from a transport vehicle that conveniently has access to the front end 3F of the tank shell 3, the discharge pipe from the vehicle is connected to the exterior end 21 of the third front loading conduit 17CF which has an interior end 19 located at a top portion of the third compartment C. Thus the granular material discharged from the pipe will flow through the conduit 17CF and into compartment C. During this process air from compartment C will vent out through the rear loading conduit 17CR. A similar arrangement of loading conduits 17 can be provided for a tank shell with a single compartment, or a large plurality of compartments.

It may be that granular material will be removed from the apparatus 1 by belt or auger conveyors with an intake end that can simply be placed under the outlet openings 13 to receive material. Often however it will be desired to remove material with a pneumatic conveyor as well, and the illustrated apparatus 1 therefore also includes a material removal circuit 30, schematically illustrated in FIG. 4, connected to each outlet opening 13 and operative to allow a pressure pipe from a pneumatic conveyor to be connected to the circuit 30 in proximity to either one of the front end 3F and the rear end 3R of the tank shell 3 to direct an air stream into the circuit 30. The illustrated circuit 30 also allows a discharge pipe to be connected to the circuit 30 in proximity to either one of the front end 3F and the rear end 3R of the tank shell 3 to receive the air stream from the circuit 30 and any granular material discharged from the outlet openings 13. Thus air can be directed into or out of the circuit at either end of the apparatus 1. A pressure pipe from a pneumatic conveyor can be connected at either end to direct an empty air stream into the circuit 30, and a discharge pipe can be connected at either end to receive an air stream carrying granular material and direct it into a transport vehicle. Convenient connection is thus available where the pneumatic conveyor is mounted on the transport vehicle, and also where it is mounted on a separate vehicle.

To further increase the versatility of the apparatus 1, the apparatus 1 is configured such that a discharge pipe connected to the circuit 30 in proximity to either end of the tank shell 3 can be connected to an external end 21 of a loading conduit 17 such that granular material flowing out of the outlet opening 13 of one of the compartments can be conveyed into another one of the compartments. Granular material from two of the compartments can be drawn into the circuit 30 and mixed together, and the blended granular material can then be directed into the third compartment.

The illustrated material removal circuit 30 comprises a pressure conduit 31 having a front pressure port 32F at a front end thereof located in proximity to the front end 3F of the tank shell 3, and a rear pressure port 32R at a rear end thereof located in proximity to the rear end 3R of the tank shell 3. The pressure ports 32 are adapted for connection to a pressure pipe from a pneumatic conveyor to receive the air stream. Each pressure port 32 is operative to prevent air in the pressure conduit from exiting through the pressure port 32. In the illustrated apparatus 1, a one-way valve 33 is provided at each pressure port 32 such that air can enter the port 32 but cannot exit the port 32. Similarly a manual valve or a cap could be provided.

A discharge conduit 35 has a front discharge port 36F at a front end thereof located in proximity to the front end 3F of the tank shell 3, and a rear discharge port 36R at a rear end thereof located in proximity to the rear end 3F of the tank shell 3. The discharge ports 36 are adapted for connection to a discharge pipe to direct an air stream carrying granular material out of the circuit 30 and into the discharge pipe to be conveyed as desired. Each discharge port 36 can be selectively open or closed with a manual valve, cap, or the like. The outlet openings 13 from the compartments A, B, C are connected to mid portions of the discharge conduit 35 such that granular material discharged from the openings 13 enters the discharge conduit 35.

To complete the circuit, a front flow conduit 37 connects a front portion of the pressure conduit 31 to a front portion of the discharge conduit 35, and a rear flow conduit 39 connects a rear portion of the pressure conduit 31 to a rear portion of the discharge conduit 35. Front and rear flow valves 40F, 40R are operative to open and close the corresponding front and rear flow conduits 37, 39.

Considerable versatility is provided by the illustrated network of conduits on the apparatus 1. By connecting a pressure pipe to the front pressure port 32F, and connecting a discharge pipe to the front discharge port 36F, closing front flow valve 40F, opening rear flow valve 40R, closing rear discharge port 36R, the air stream from the pressure pipe will pass along the pressure conduit 31 to the rear end, then through the rear flow conduit 39 to the discharge conduit 35, forward along the discharge conduit 35, picking up any granular material discharged from any compartment, and then out through the front discharge port 36F into the discharge pipe which has its opposite end located to discharge the granular material where desired.

Alternatively by connecting a pressure pipe to the front pressure port 32F, and connecting a discharge pipe to the rear discharge port 36R, opening front flow valve 40F, closing rear flow valve 40R, closing front discharge port 36F, the air stream from the pressure pipe will pass through the front flow conduit 37 to the discharge conduit 35, rearward along the discharge conduit 35, picking up any granular material discharged from any compartment, and then out through the rear discharge port 36R into the discharge pipe which again has its opposite end located to discharge the granular material where desired.

Similar options are available when the pressure pipe is connected to the rear pressure port 32R. Also it can be seen that with a relatively short connector pipe, each front and rear discharge port 36F, 36R can be connected to a corresponding exterior end 21 of one of the front and rear loading pipes 17F, 17R to direct granular material from one or two compartments into a third of the compartments. For example where the material removal circuit 30 is connected to discharge the air stream carrying granular material out through the rear discharge port 36R, that rear discharge port can be connected to the exterior end 21 of the rear loading conduit 17BR. The air stream carrying granular material will be directed into compartment B and the air will vent from compartment B out through the front loading conduit 17BF.

The illustrated apparatus also includes top air conduits 45A, 45B, 45C connecting the pressure conduit 31 to a top portion of the corresponding first, second, and third compartments A, B, C. Valves 47 operate to selectively open and close each of top air conduits. Closure mechanisms, such as loading conduit valves 48 or caps or the like, are provided so that the loading conduits may be closed to allow pressure to build up in a selected compartment.

Thus where it is desired to withdraw granular material from compartment A, the loading conduits 17AF, 17AR are closed, the valve 47 in top air conduit 45A is opened to equalize pressure above the granular material in compartment A, and the gate 15 in the bottom of compartment A is opened, allowing granular material to enter the discharge conduit 35 and be carried away. When the desired amount of granular material has been removed, the gate 15 and valve 47 in top air conduit 45A will be closed. A bleed off valve 49 in the top air conduit 45A can be opened to connect the compartment A to the atmosphere exterior to the tank shell 3 and bleed off any pressure remaining therein, or where convenient one of the loading conduits 17AF, 17AR can be opened. A pressure relief valve 51 can be provided connected to each compartment to release pressure inside should the pressure rise to an unacceptable level.

The interior walls 9 must be designed to withstand the force developed by the pressure differential when the compartment on one side of the wall 9 is pressurized and the compartment on the other side is not. As seen in FIG. 1, the interior wall 9 is dome shaped, but it could be conical, or otherwise reinforced to withstand the forces developed thereon.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A portable storage tank apparatus for storing granular material, the apparatus comprising:
a tank shell mounted on wheels and adapted to be towed to a work site by a towing vehicle, and adapted to be supported at the work site to receive and store granular material;
an outlet opening at a bottom portion of the tank shell and a gate operative to selectively discharge stored granular material through the outlet opening;
a front loading conduit having an interior end located inside the tank shell at a top portion of an interior of the tank shell and an exterior end located in proximity to a front end of the tank shell;
a rear loading conduit having an interior end located inside the tank shell at a top portion of the interior of the tank shell and an exterior end located in proximity to a rear end of the tank shell;
wherein the exterior ends of the front and rear loading conduits are adapted for connection to a discharge pipe of a pneumatic conveyor to receive an air stream carrying granular material from the discharge pipe.

2. The apparatus of claim 1 comprising a material removal circuit connected to the outlet opening and operative to allow a pressure pipe from a pneumatic conveyor to be connected to the circuit in proximity to either one of the front end and the rear end of the tank shell to direct an air stream into the circuit, and operative to allow a discharge pipe to be connected to the circuit in proximity to either one of the front end and the rear end of the tank shell to receive the air stream and any granular material discharged from the outlet opening.

3. The apparatus of claim 2 wherein the material removal circuit comprises:
a pressure conduit having a front pressure port at a front end thereof located in proximity to the front end of the tank shell, and a rear pressure port at a rear end thereof located in proximity to the rear end of the tank shell, each pressure port adapted for connection to the pressure pipe to receive the air stream from the pneumatic conveyor, and each pressure port operative to prevent air in the pressure conduit from exiting through the pressure port;
a discharge conduit having a front discharge port at a front end thereof located in proximity to the front end of the tank shell, and a rear discharge port at a rear end thereof located in proximity to the rear end of the tank shell, each discharge port adapted for connection to the discharge pipe, and each discharge port configured to be selectively open or closed;
wherein the outlet opening of the tank shell is connected to a mid portion of the discharge conduit such that granular material discharged from the outlet opening enters the discharge conduit;
a front flow conduit connecting a front portion of the pressure conduit to a front portion of the discharge conduit, and a front flow valve operative to open and close the front flow conduit; and
a rear flow conduit connecting a rear portion of the pressure conduit to a rear portion of the discharge conduit, and a rear flow valve operative to open and close the rear flow conduit.

4. The apparatus of claim 3 further comprising a top air conduit connecting the pressure conduit to a top portion of the tank shell, and a valve operative to open and close the top air conduit, and a closure mechanism operative to selectively open and close the loading conduits.

5. The apparatus of claim 4 further comprising a bleed off valve in the top air conduit selectively operative to connect the interior of the tank shell to an atmosphere exterior to the tank shell.

6. The apparatus of claim 5 further comprising a pressure relief valve operative to release pressure inside the interior of the tank shell.

7. A portable storage tank apparatus for storing granular material, the apparatus comprising:
a tank shell mounted on wheels and adapted to be towed to a work site by a towing vehicle, and adapted to be supported at the work site to receive and store granular material;
a wall dividing an interior of the tank shell into first and second compartments such that air is prevented from moving between the first and second compartments
first and second outlet openings at bottom portions of the corresponding first and second compartments and first and second gates operative to selectively discharge stored granular material through the corresponding first and second outlet openings;
a first front loading conduit having an interior end located at a top portion of the first compartment, and an exterior end located in proximity to a front end of the tank shell;
a second front loading conduit having an interior end located at a top portion of the second compartment, and an exterior end located in proximity to a front end of the tank shell;
a first rear loading conduit having an interior end located at a top portion of the first compartment, and an exterior end located in proximity to a rear end of the tank shell;
a second rear loading conduit having an interior end located at a top portion of the second compartment, and an exterior end located in proximity to a rear end of the tank shell;
wherein the exterior ends of the loading conduits are adapted for connection to a discharge pipe of a pneumatic conveyor to receive an air stream carrying granular material from the discharge pipe.

8. The apparatus of claim 7 comprising a material removal circuit connected to the first and second outlet openings and operative to allow a pressure pipe from a pneumatic conveyor to be connected to the circuit in proximity to either one of the front end and the rear end of the tank shell to direct an air stream into the circuit, and operative to allow a discharge pipe to be connected to the circuit in proximity to either one of the front end and the rear end of the tank shell to receive the air stream and any granular material discharged from the first and second outlet openings.

9. The apparatus of claim 8 wherein the material removal circuit comprises:
a pressure conduit having a front pressure port at a front end thereof located in proximity to the front end of the tank shell, and a rear pressure port at a rear end thereof located in proximity to the rear end of the tank shell, each pressure port adapted for connection to the pressure pipe to receive the air stream from the pneumatic conveyor, and each pressure port operative to prevent air in the pressure conduit from exiting through the pressure port;
a discharge conduit having a front discharge port at a front end thereof located in proximity to the front end of the tank shell, and a rear discharge port at a rear end thereof located in proximity to the rear end of the tank shell, each discharge port adapted for connection to the discharge pipe, and each discharge port configured to be selectively open or closed;
wherein the first and second outlet openings are connected to mid portions of discharge conduit such that granular material discharged from the first and second outlet openings enters the discharge conduit;
a front flow conduit connecting a front portion of the pressure conduit to a front portion of the discharge conduit, and a front flow valve operative to open and close the front flow conduit; and
a rear flow conduit connecting a rear portion of the pressure conduit to a rear portion of the discharge conduit, and a rear flow valve operative to open and close the rear flow conduit.

10. The apparatus of claim 9 further comprising first and second top air conduits connecting the pressure conduit to a top portion of the corresponding first and second compartments, and first and second valves operative to open and close the corresponding first and second top air conduits, and closure mechanisms operative to selectively open and close the loading conduits.

11. The apparatus of claim 10 further comprising a bleed off valve in at least one top air conduit selectively operative to connect a compartment connected to the at least one top air conduit to an atmosphere exterior to the tank shell.

12. The apparatus of claim 11 further comprising at least one pressure relief valve operative to release pressure inside at least one of the first and second compartments.

13. A portable storage tank apparatus for storing granular material, the apparatus comprising:
a tank shell mounted on wheels and adapted to be towed to a work site by a towing vehicle, and adapted to be supported at the work site to receive and store granular material;
interior walls dividing an interior of the tank shell into first, second, and third compartments such that air is prevented from moving between the compartments;
first, second, and third outlet openings at bottom portions of the corresponding first, second, and third compartments and first, second, and third gates operative to selectively discharge stored granular material through the corresponding first, second, and third outlet openings;
a first front loading conduit having an interior end located at a top portion of the first compartment, and an exterior end located in proximity to a front end of the tank shell;
a second front loading conduit having an interior end located at a top portion of the second compartment, and an exterior end located in proximity to the front end of the tank shell;
a third front loading conduit having an interior end located at a top portion of the third compartment, and an exterior end located in proximity to the front end of the tank shell;
a first rear loading conduit having an interior end located at a top portion of the first compartment, and an exterior end located in proximity to a rear end of the tank shell;
a second rear loading conduit having an interior end located at a top portion of the second compartment, and an exterior end located in proximity to the rear end of the tank shell;
a third rear loading conduit having an interior end located at a top portion of the third compartment, and an exterior end located in proximity to the rear end of the tank shell;
wherein the exterior ends of the loading conduits are adapted for connection to a discharge pipe of a pneumatic conveyor to receive an air stream carrying granular material from the discharge pipe.

14. The apparatus of claim 13 comprising a material removal circuit connected to the outlet openings and operative to allow a pressure pipe from a pneumatic conveyor to be connected to the circuit in proximity to either one of the front end and the rear end of the tank shell to direct an air stream into the circuit, and operative to allow a discharge pipe to be connected to the circuit in proximity to either one of the front end and the rear end of the tank shell to receive the air stream and any granular material discharged from the outlet openings.

15. The apparatus of claim 14 wherein a discharge pipe connected to the circuit in proximity to either one of the front end and the rear end of the tank shell can be connected to an external end of a loading conduit such that granular material flowing out of the first outlet opening can be conveyed into one of the second and third compartments.

16. The apparatus of claim 14 wherein a discharge pipe connected to the circuit in proximity to either one of the front end and the rear end of the tank shell can be connected to an external end of a loading conduit such that granular material flowing out of the first and second outlet openings can be conveyed into the third compartment.

17. The apparatus of claim 14 wherein the material removal circuit comprises:
a pressure conduit having a front pressure port at a front end thereof located in proximity to the front end of the tank shell, and a rear pressure port at a rear end thereof located in proximity to the rear end of the tank shell, each pressure port adapted for connection to the pressure pipe to receive the air stream from the pneumatic conveyor, and each pressure port operative to prevent air in the pressure conduit from exiting through the pressure port;
a discharge conduit having a front discharge port at a front end thereof located in proximity to the front end of the tank shell, and a rear discharge port at a rear end thereof located in proximity to the rear end of the tank shell, each discharge port adapted for connection to the discharge pipe, and each discharge port configured to be selectively open or closed;
wherein the first, second, and third outlet openings are connected to mid portions of the discharge conduit such that granular material discharged therefrom enters the discharge conduit;
a front flow conduit connecting a front portion of the pressure conduit to a front portion of the discharge conduit, and a front flow valve operative to open and close the front flow conduit; and
a rear flow conduit connecting a rear portion of the pressure conduit to a rear portion of the discharge conduit, and a rear flow valve operative to open and close the rear flow conduit.

18. The apparatus of claim 17 further comprising first, second, and third top air conduits connecting the pressure conduit to a top portion of the corresponding first, second, and third compartments, and first, second, and third valves operative to open and close the corresponding first, second, and third top air conduits, and closure mechanisms operative to selectively open and close the loading conduits.

19. The apparatus of claim 18 further comprising a bleed off valve in at least one top air conduit selectively operative to connect a compartment connected to the at least one top air conduit to an atmosphere exterior to the tank shell.

20. The apparatus of claim 19 further comprising a pressure relief valve operative to release pressure inside at least one of the first, second, and third compartments.
